(19) United States
(12) Patent Application Publication
(10) Pub. No.: US 2017/0267218 A1
(43) Pub. Date: Sep. 21, 2017

(54) A SENSOR DEVICE FOR A BRAKING SYSTEM EQUIPPED WITH AN ELECTROMECHANICAL BRAKE BOOSTER AND A METHOD FOR ASCERTAINING A BRAKING REQUEST SPECIFICATION TO A BRAKING SYSTEM EQUIPPED WITH AN ELECTROMECHANICAL BRAKE BOOSTER

(71) Applicant: Robert Bosch GmbH, Stuttgart (DE)

(72) Inventor: Michael BUNK, Leingarten (DE)

(21) Appl. No.: 15/309,834

(22) PCT Filed: Mar. 31, 2015
(86) PCT No.: PCT/EP2015/056938

§ 371 Date: Nov. 9, 2016

(30) Foreign Application Priority Data
Jun. 4, 2014 (DE) 10 2014 210 550.1

(51) Int. Cl. B60T 7/04; B60T 8/172; B60T 13/74

(52) U.S. Cl. CPC B60T 7/042; B60T 13/745; B60T 13/746; B60T 8/172; B60T 2270/10; B60T 2270/30; B60T 2220/04

(57) ABSTRACT

A sensor device for a braking system equipped with an electromechanical brake booster, including evaluation electronics, which are configured to determine at least one braking request specification variable, while taking into account at least one actual variable with respect to a functionality of at least one component of the electromechanical brake booster and/or at least one setpoint variable for specifying the functionality of the at least one component of the electromechanical brake booster as a provided variable. A controller for a braking system equipped with an electromechanical brake booster, a braking system for a vehicle, a method for ascertaining a braking request specification variable to a braking system equipped with an electromechanical brake booster, and a method for operating a braking system equipped with an electromechanical brake booster, are also described.

### FIELD

The present invention relates to a sensor device for a braking system equipped with an electromechanical brake booster. The present invention also relates to a controller for a braking system equipped with an electromechanical brake booster and to a braking system for a vehicle. In addition, the present invention relates to a method for ascertaining a braking request specification to a braking system equipped with an electromechanical brake booster and to a method for operating a braking system equipped with an electromechanical brake booster.

### BACKGROUND INFORMATION

A method and a device for operating a braking assistance system are described in German Patent Application No. DE 10 2009 000 294 A1. In order to ascertain whether the braking behavior of the driver is typical for an emergency brake application, a driver primary pressure is measured as a physical variable, which is said to be characteristic of the brake actuation by the driver. To ascertain the driver primary pressure, a primary pressure sensor attached to the master brake cylinder is used in the braking system of German Patent Application No. DE 10 2009 000 294 A1, which is equipped with a vacuum brake booster. An emergency braking situation is said to be detectable based on the driver primary pressure and, if necessary, an automatic emergency brake application may be carried out.

FIG. 1a through 1c show coordinate systems for explaining the driver primary pressure, which occurs in conventional braking systems. In the coordinate systems of FIG. 1a through 1c, each x-axis is the time axis t. The y-axes of the coordinate systems of FIG. 1a through 1c reflect a pressure P in each case.

In each coordinate system of FIG. 1a through 1c, a graph F is delineated, which reflects a driver braking request of the user of the braking system (as setpoint braking pressure to be built up in the wheel brake cylinders of the respective braking system). The simultaneously occurring driver primary pressure is plotted with a graph p1, p2 or p3 in the coordinate systems of FIG. 1a through 1c. (Driver primary pressure may also be understood to mean a master brake cylinder pressure occurring in the master brake cylinder of the respective braking system).

The coordinate systems of FIGS. 1a and 1b provide examples of a braking system equipped with a vacuum brake booster such as, for example, the braking system of German Patent Application No. DE 10 2009 000 294 A1. In the example of FIG. 1a, the at least one pump and the valves of the braking system equipped with the vacuum brake booster are deactivated by the user/driver during the specification of the driver braking request corresponding to graph F. Thus, the at least one pump of the braking system equipped with the vacuum brake booster is not operated to pump brake fluid during the specification of the driver braking request corresponding to graph F. Nor is any wheel pressure regulation of individual wheels carried out by controlling various valves of the braking system equipped with the vacuum brake booster. This may be described as a passive presence of an ESP system of the respective brake system during the specification of the driver braking request. In the example of FIG. 1a, therefore, there is a relation between graph F and graph p1, graph p1 deviating from graph F by a predefined constant.

In the example of FIG. 1b on the other hand, the at least one pump of the braking system equipped with the vacuum brake booster is operated/activated and/or valves are switched for pumping brake fluid at the time of the driver braking request depicted in graph F. Thus, the ESP system of the braking system equipped with the vacuum brake booster is active during the specification of the driver braking request. For this reason, significant fluctuations occur in the driver primary pressure depicted with the aid of graph p2, which are attributable to the operation of the at least one pump and/or the switching of the valves.

Graph p3 of the coordinate system of FIG. 1c depicts a driver primary pressure of a modified braking system, the modified braking system including an electromechanical brake booster instead of the vacuum brake booster of the braking system of German Patent Application No. DE 10 2009 000 294 A1. In addition, as in the example of FIG. 1b, the at least one pump of the braking system equipped with the electromechanical brake booster is operated/activated or valves are switched to pump brake fluid at the time of the driver braking request depicted in graph F. Since the electromechanical brake booster exerts only a very minimal spring force for damping an operation of the at least one pump and/or the switching of the valves of the braking system, the fluctuations of graph p3 are more significant than in the preceding example. In particular, the driver primary pressure equals zero during a time interval Δt, even though at the same time the driver requests a setpoint braking pressure unequal to zero.

### SUMMARY

The present invention provides a sensor device for a braking system equipped with an electromechanical brake booster, a controller for a braking system equipped with an electromechanical brake booster, a braking system for a vehicle, a method for ascertaining a braking request specification to a braking system equipped with an electromechanical brake booster, and a method for operating a braking system equipped with an electromechanical brake booster.

The present invention provides an advantageous option for ascertaining the braking request specification of a user of a braking system including an electromechanical brake booster. Here, the present invention exploits the fact that the electromechanical brake booster and the driver braking request have inherently the same dynamic. This is a significant advantage compared to the ascertainment of a braking request specification of the user based on a hydraulic variable of the hydraulics of the braking system such as, for example, of the driver primary pressure/primary pressure or of the master brake cylinder pressure, since a hydraulic time constant of such a hydraulic variable is significantly less than a mechanical time constant of the electromechanical brake booster. The hydraulic time constant is typically in the range of a few milliseconds, whereas the mechanical time constant of the electromechanical brake booster, conditional largely upon its mass inertia and its time-discrete control, is often greater, for example, in the range of several tens of milliseconds. (Even a time constant of a braking request specification by the user of the braking system equipped with the electromechanical brake booster is frequently in the range of several tens of milliseconds).

With the aid of the present invention, however, it is possible to use the driver primary pressure/primary pressure or master cylinder pressure at most on a conditional basis for ascertaining the driver braking request. With the aid of the present invention, it is, in particular, possible to determine the at least one braking request specification variable without taking the driver primary pressure/primary pressure or master brake cylinder pressure into account. Thus, no problems occur when carrying out/utilizing the present invention, which are caused by a deviation of the dynamics of the braking request specification and the at least one variable evaluated for such purpose.

The present invention is applicable in all braking systems equipped with an electromechanical brake booster. A relatively reliable and error-free determination of the at least one braking request specification variable is ensured, despite the comparatively low elasticity of the electromechanical brake booster (as compared to a vacuum brake booster, for example).

The present invention is particularly suitable for hybridized vehicles, because it is with these, in particular, that the behavior of a vacuum brake booster is simulated through adaptation of the transfer functions (described in greater detail below) of the electromechanical brake booster. This operation is generally also carried out if the vehicle is decelerated purely electrically or via a generator. Since an ascertainment of the driver primary pressure/primary pressure or master brake cylinder pressure for examining the braking request specification is not helpful in this case, numerous novel possibilities for examining the braking request specification to a hybridized vehicle result from the present invention.

In one particularly advantageous specific embodiment of the sensor device, the evaluation electronics are configured to determine the at least one braking request specification variable, while taking into account a motor current to be supplied and/or supplied to a motor of the electromechanical brake booster, a motor voltage to be applied and/or applied to the motor of the electromechanical brake booster, a motor power to be applied and/or applied by the motor of the electromechanical brake booster, a motor rotation angle to be carried out and/or carried out by the motor of the electromechanical brake booster, a rotation speed to be carried out and/or carried out by the motor of the electromechanical brake booster, an adjustment travel of at least one component of a mechanism of the electromechanical brake booster to be carried out and/or carried out and/or a force to be applied and/or applied to the at least one component of the mechanism of the electromechanical brake booster as the at least one actual variable and/or the at least one setpoint variable. Thus, to determine the at least one braking request specification variable, the evaluation electronics may utilize at least one actual variable, which may be ascertained with the aid of a sensor, which is easily installable or already present in the vehicle. To determine the at least one braking request specification variable, the evaluation electronics may, in particular, also use at least one setpoint variable, which was previously determined by a vehicle-internal control device and is therefore easily providable to the sensor device.

The evaluation electronics may also be configured to determine an operation performed by the user of the braking system on a braking actuation element situated thereon as the at least one braking request specification variable, while taking the at least one actual variable and/or the at least one setpoint variable into account. The determination of the operation performed on the brake actuation element is advantageous compared to a conventional determination of a pedal travel (of the brake actuation device designed as a brake pedal), since the operation performed on the brake actuation element is not influenced/barely influenced by a closing of at least one of the valves of the hydraulics of the braking system. In contrast, an increase in the pedal travel is frequently no longer possible after the closing of at least one of the valves of the hydraulics such as, for example, a brake circuit separating valve, which is why the pedal travel in this case is of only limited suitability for reproducing a braking request.

The evaluation electronics may be designed, for example, to determine at least one input rod travel of an input rod of the electromechanical brake booster and a first adjustment force applied to the input rod, while taking the at least one actual variable and/or the at least one setpoint variable into account, and to determine the operation performed by the user of the braking system on the brake actuation element, while taking the input rod travel and the first adjustment force into account. In addition, the evaluation electronics may also be designed to determine at least one output rod travel of an output rod of the electromechanical brake booster and a second adjustment force applied to the output rod, while taking the at least one actual variable and/or the at least one setpoint variable into account, and to determine the input rod travel and the first adjustment force, while taking the output rod travel and the second adjustment force into account.

The advantages enumerated above are also ensured in the case of a controller for a braking system equipped with an electromechanical brake booster including such a sensor device.

An ABS regulation, an ESP regulation, an ACC regulation, a recuperation regulation, a regulation of an auxiliary braking system, a regulation of a hydraulic brake booster and/or a regulation of a generator of the braking system may be advantageously carried out with the aid of the controller, while taking the at least one braking request specification variable into account. The accurate and error-free determination of the at least one braking request specification variable may therefore be utilized for a variety of braking functions. A braking system for a vehicle including an electromechanical brake booster and a corresponding sensor device/controller also provides the advantages described above.

The advantages described above may also be implemented by carrying out a corresponding method for ascertaining a braking request specification to a braking system equipped with an electromechanical brake booster. The method is further refinable according to the specific embodiments of the sensor device described above.

In addition, the aforementioned advantages are also ensured by carrying out a corresponding method for operating a braking system equipped with an electromechanical brake booster. In this case as well, the method according to the specific embodiments of the sensor device/controller described above is further refinable.

### BRIEF DESCRIPTION OF THE DRAWINGS

Additional features and advantages of the present invention are explained below with reference to the figures.

FIG. 1a through 1c show coordinate systems for explaining the driver primary pressure occurring in conventional braking systems.

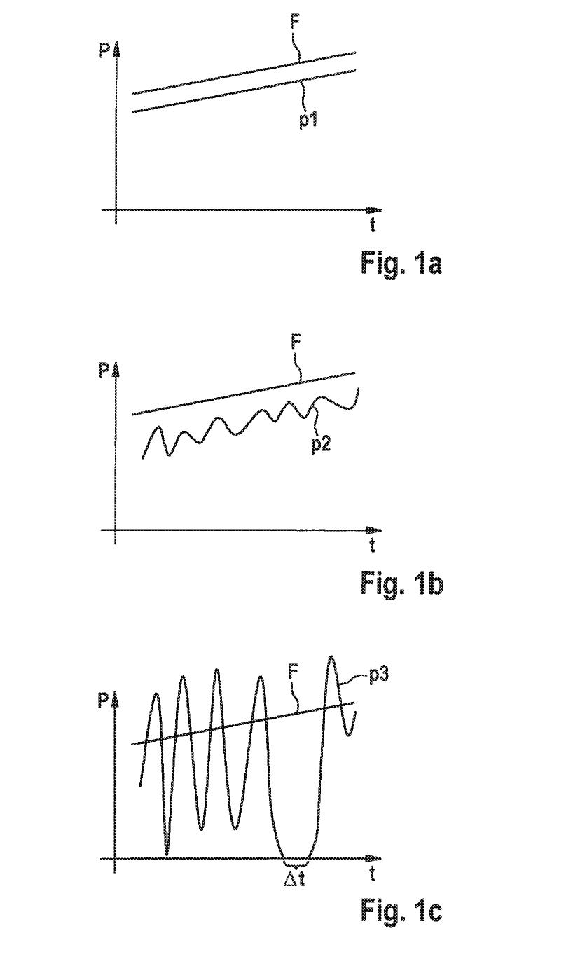

FIG. 2 schematically shows a depiction of a specific embodiment of the sensor device.

FIG. 3 shows a flow chart for explaining a specific embodiment of the method for ascertaining a braking request specification to a braking system equipped with an electromechanical brake booster.

### DETAILED DESCRIPTION OF EXAMPLE EMBODIMENTS

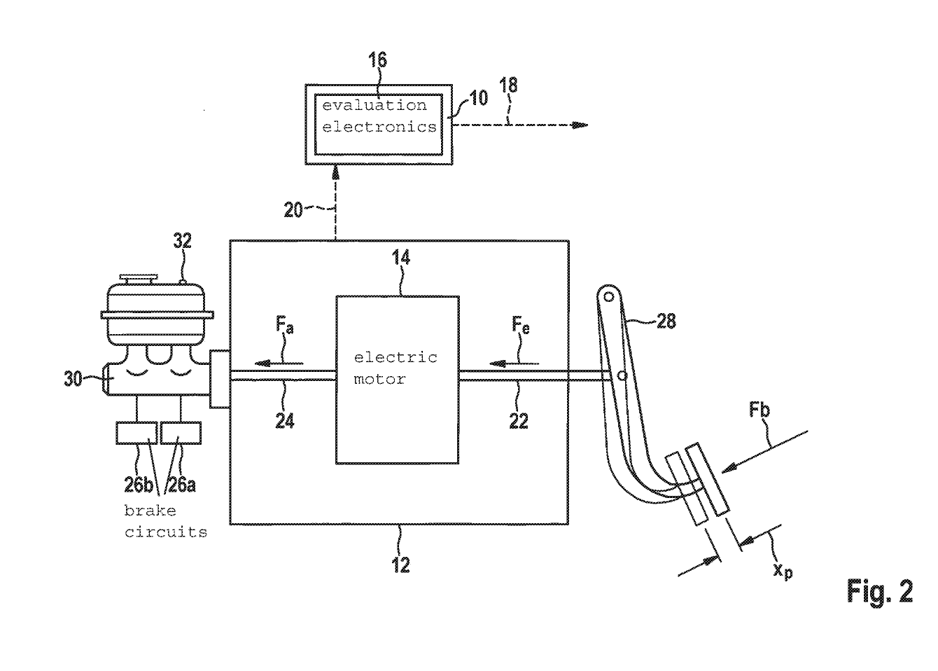

FIG. 2 schematically shows a depiction of one specific embodiment of the sensor device.

Sensor device 10 schematically depicted in FIG. 2 is designed to cooperate with a braking system, which is equipped with an electromechanical brake booster 12. Sensor device 10 is preferably installable in and/or on the braking system equipped with electromechanical brake booster 12 or in and/or on a vehicle including the braking system. It is noted that the applicability of sensor device 10 is not limited to a particular type of brake booster or to a particular type of braking system. Thus, any braking system, which includes a brake booster having an (electric) motor 14 definable as an electromechanical brake booster 12, may be equipped with sensor device 10.

Sensor device 10 includes evaluation electronics 16, which are configured to determine at least one braking request specification variable 18 with respect to a braking request specification of a user of the braking system. In addition, evaluation electronics 16 are configured to determine the at least one braking request specification variable 18, while taking at least one provided variable 20 into account. The at least one braking request specification variable 18 may, for example, be determinable with respect to an (examined) functionality of at least one component 14, 22 and 24 of electromechanical brake booster 12, while taking at least one (ascertained or measured) actual variable into account. As an alternative or in addition thereto, the determination of the at least one braking request specification variable 18 for specifying the functionality of the at least one component 14, 22 and 24 of electromechanical brake booster 12 may also be carried out, while taking at least one (determined or calculated) setpoint variable 20 into account. The at least one component 14, 22 and 24 of electromechanical brake booster 12 may, for example, be motor 14, an actuator (not delineated) of electromechanical brake booster 12 and/or at least one component 22 and 24 of a mechanism of electromechanical brake booster 12 such as, in particular, an input rod 22 and/or an output rod 24 of electromechanical brake booster 12. The examples for the at least one component 14, 22 and 24 of electromechanical brake booster 12 enumerated here are only to be interpreted as exemplary. Advantageous examples for the at least one actual variable and the at least one setpoint variable 20 are still enumerated below.

Thus, sensor device 10 utilizes the advantageous connection and design of electromechanical brake booster 12, as a result of which a dynamic of electromechanical brake booster 12 equal to a dynamic of the braking request specification of a user of the braking system/of a driver is ensured. Specifically, sensor device 10 utilizes an event chain inherent in the braking system for determining the at least one braking request specification variable 18. In particular, sensor device 10 takes advantage of the fact that the operation of electromechanical brake booster 12 is generally adapted in accordance with Newton's Third Law (“action=reaction”) to the braking request specification of the user by actuating a brake actuation element 28 of the braking system such as, for example, a brake pedal 28. In general, electromechanical brake booster 12 is operated (for example, by its control electronics) in such a way that a driver braking force Fb of the user applied to brake actuating element 28 counteracts an oppositely directed force having the same absolute value. In this way, the dynamics of electromechanical brake booster 12 are adapted automatically to the dynamics of driver braking force Fb.

Thus, sensor device 10 is able to respond in a timely manner to changes to the braking request specification by the user/driver with the aid of a redetermination of the at least one braking request specification variable 18. At the same time, it is ensured that the determination of the at least one braking request specification variable 18 is not impaired/distorted by a braking system component of at least one brake circuit 26a and 26b of the braking system having faster dynamics. Significantly faster dynamics compared to the dynamics of the braking request specification are present, for example, during an operation of at least one pump and/or switching of the valves of the at least one brake circuit 26a and 26b of the braking system. By taking the at least one actual variable and/or the at least one setpoint variable 20 into account when determining the at least one braking request specification variable 18, it is ensured that the operation of the at least one pump does not affect/barely affects the determination of the at least one braking request specification variable 18. Nor is a functionality/reliability of control device 10 influenced by a separation/decoupling of a wheel brake cylinder of brake circuits 26a and 26b from a master brake cylinder 30 and or a brake fluid reservoir 32 of the braking system. Thus, sensor device 10 permits a more accurate, better timed and error-free determination of the at least one braking request specification variable 18.

Electromechanical brake booster 12 schematically depicted in FIG. 2 includes an input rod 22 and an output rod 24 as the at least one component of its mechanism. Motor 14 of electromechanical brake booster 12 is controlled/regulated in such a way that a braking of the driver into the master brake cylinder 30 connected to electromechanical brake booster 12 (at least in certain operating situations) is forcefully assisted. Thus, it is ensurable that the driver (at least in certain operating situations) is able to effectuate a sufficiently high braking pressure in at least one wheel brake cylinder (not delineated) of brake circuit 26a and 26b connected to master brake cylinder 30 just with the aid of a relatively low driver braking force Fb.

Evaluation electronics 16 are preferably configured to determine the at least one braking request specification variable 18, while taking into account a (setpoint) motor current to be provided to motor 14 of electromechanical brake booster 12, a (setpoint) motor voltage to be applied to motor 14 of electromechanical booster 12, a (setpoint) motor power to be applied by motor 14 of electromechanical brake booster 12, a (setpoint) motor rotation angle to be carried out by motor 14 of electromechanical brake booster 12, a (setpoint) rotation speed (of a rotor) of motor 14 to be carried out, an adjustment travel of the at least one component 22 and 24 of the mechanism of the electromechanical brake booster to be carried out and/or a force to be applied to the at least one component 22 and 24 of the mechanism of electromagnetic brake booster 12 as the at least one setpoint variable 20. Since such a setpoint variable 20 for controlling electromechanical brake booster 12, in particular, for controlling its motor 14 and/or its actuator is generally previously determined, it is possible to also utilize previously determined values for operating evaluation electronics 16.

Alternatively or in addition, evaluation electronics 16 may also be configured to determine the at least one braking request specification variable 18, while taking into account a motor current provided to motor 14 of electromechanical brake booster 12, a motor voltage applied to motor 14 of electromechanical brake booster 12, a motor power applied by motor 14 of electromechanical brake booster 12, a motor rotation angle carried out by motor 14 of electromechanical brake booster 12, a rotation speed (of a rotor) of motor 14 carried out, an adjustment travel of the at least one component of the mechanism of electromechanical brake booster 12 carried out and/or a force applied to the at least one component of the mechanism of electromechanical brake booster 12 as the at least one (measured) actual variable. Since the actual variables enumerated herein are frequently already ascertained/measured for monitoring the operation of electromechanical brake booster 12, the use of sensor device 10 requires no additional sensors on the braking system with which it cooperates.

Sensor device 10, once it has determined the at least one braking request specification variable 18, may provide this, for example, to a driver assistance device such as, for example, an ABS control device, an ESP control device, an ACC control device, a recuperation control device, a control device of an auxiliary braking system, a control device for hydraulic brake boosting and/or a control device of a generator of the braking system. The at least one determined braking request specification variable 18 may be communicated, for example, via the network for the driver assistance device installed in the vehicle. Likewise, however, sensor device 10 may also be a subunit of a controller for the braking system equipped with electromechanical brake booster 12. The controller in this case may be configured to carry out a driver assistance function such as, for example, an ABS regulation, an ESP regulation, an ACC regulation, a recuperation regulation, a regulation of an auxiliary braking system, a regulation of a hydraulic brake booster and/or a regulation of a generator of the braking system, while taking the at least one braking request specification variable 18 into account. The advantages of the reliable, accurate and error-free determination of the at least one braking request specification variable 18 may thus be utilized for a variety of driver assistance functions. The at least one determined braking request specification variable 18 may also be used for controlling/checking a deceleration of the vehicle equipped with sensor device 10.

In the specific embodiment of FIG. 2, evaluation electronics 16 are configured to determine an operation W performed by the user of the braking system on brake actuation element 28 as the at least one braking request specification variable 18. The operation W performed by the user of the braking system on brake actuation element 28 is defined according to equation (Eq. 1) as

W=∫₀^{x}^{ₚ}Fb dx (Eq. 1)

xₚ representing a pedal travel, by which brake actuation element 28 designed as brake pedal 28 is moved from its (powerless) starting position with the aid of driver braking force Fb. (Any other definition of the driver braking request as a function of driver braking force Fb and of pedal travel xₚ is also possible).

By actuating brake actuation element/brake pedal 28, input rod 22 is moved (from its powerless starting position) by an input rod travel xₑ, which is defined according to equation (Eq. 2) as:

xₑ=iₚ*xₗ (Eq. 2)

In addition, a first adjustment force Fₑ is transferred to input rod 22 with the aid of the actuation of brake actuation element/brake pedal 28 according to equation (Eq. 3):

Fₑ=1/iₚ*Fₚ= (Eq. 3)

In both equations (Eq. 1) and (Eq. 3), the constant iₚ is a mechanically predefined (constant) pedal ratio.

In the specific embodiment of FIG. 2, sensor device 10 foregoes an ascertaining/measuring of input rod travel xₑ and of first adjustment force Fₑ applied to input rod 22. Thus, the need to situate a force sensor and/or travel sensor near input rod 22 is eliminated.

Instead, sensor device 10 exploits the fact that a second adjustment force Fₐ is applied to output rod 24 during the operation of electromechanical brake booster 12 with the aid of motor 14 of electromechanical brake booster 12 (and potentially also by the transfer of first adjustment force Fₑ), with the aid of which output rod 24 is moved (from its powerless starting position) by an output rod travel xₐ. Output rod travel Xₐ and second adjustment force Fₐ applied to output rod 24 are each functions of input rod travel xₑ and of first adjustment force Fₑ transferred to input rod 22 according to the following equations (Eq. 4) and (Eq. 5):

xₐ=Gₓ(xₑ,Fₑ) (Eq. 4)
(Transfer function of the displacement of output rod 24)

Fₐ=G_{F}(xₑ,Fₑ) (Eq. 5)
(Transfer function of the boosting of electromechanical brake booster 12)

(Thus, the driver braking request may be reliably ascertained from output rod travel xₐ and second adjustment force Fₐ transferred to output rod 24).

Similarly, input rod travel xₑ and first adjustment force Fₑ transferred to input rod 22 are also functions of output rod travel xₐ and second adjustment force Fₐ transferred to output rod 24 according to the equations (Eq. 6) and Eq. 7):

xₑ=G*ₓ(xₐ,Fₐ) (Eq. 6)

Fₑ=G*ₓ(xₐ,Fₐ (Eq. 7)

All of the aforementioned functions are determined by the design of electromechanical brake booster 12.

It is noted, purely for the sake of completeness, that in some operating modes of the braking system, master brake cylinder pressure p present in master brake cylinder 30 may result according to equation (Eq. 8) from second adjustment force Fₐ transferred to output rod 24 as:

Fₐ≈A*p, (Eq. 8)

A representing a master brake cylinder cross-sectional surface of master brake cylinder 30. As previously stated above, equation (Eq. 8) is barely applicable during an operation of the at least one pump of brake circuits 26a and 26b of the braking system. Instead, equation (Eq. 9) applies as:

$$\frac{dp}{dt} = \frac{K}{V - A \cdot {x}_{a}} * ( A * \frac{{dx}_{a}}{dt} - {q}_{1} - {q}_{2} ) \qquad ( Eq . 9 )$$

V indicates a maximum internal volume of master brake cylinder 30. (The significance of constant K is not discussed further here.) The variables q₁ and q₂ reflect a hydraulic coupling of brake circuits 26a and 26b to master brake cylinder 30. Thus, it is possible for pressure oscillations to occur in master brake cylinder 30 primarily during an operation of the at least one pump and/or at least one valve of brake circuits 26a and 26b of the braking system. (For the sake of simplicity, moments of inertia of the components involved have been disregarded in the upper equation.)

However, evaluation electronics 16 are configured to determine operation W performed by the user of the braking system on brake actuation element 28, while not taking master brake cylinder pressure p (or the primary pressure) into account. For this purpose, evaluation electronics 16 take advantage of the fact that (from the motion equation of a rotating body) a load torque M_{L} of motor 14 of electromechanical brake booster 12 results as a function of second adjustment force Fₐ transferred to output rod 24 according to equation (Eq. 10) as:

$${M}_{L} ( {F}_{a} ) = {M}_{M} - {M}_{V} - J * \frac{d ω}{dt} \qquad ( Eq . 10 )$$

Driving torque M_{M} is proportional to a motor current I of motor 14 of electromechanical brake booster 12. Loss of torque Mᵥ is dictated by design. The inertia term

$$J * \frac{d ω}{dt}$$

results from rotation speed ω of motor 14 and moment of inertia J.

In the specific embodiment described herein, a (setpoint) motor current I and a (setpoint) rotation speed (of a rotor) of motor 14 to be made available for Motor 14 for controlling electromechanical brake booster 12 are determined. (Setpoint) motor current I and (setpoint) rotation speed ω are subsequently outputted as the at least one setpoint variable 20 to sensor device 10. Thus, second adjustment force Fₐ transferred to output rod 24 may be ascertained from the at least one setpoint variable 20 for controlling motor 14 used in the electromechanical brake booster. (It is no longer necessary to use master brake cylinder pressure p (or the primary pressure) to determine second adjustment force Fₐ transferred to output rod 24.) Similarly, output rod travel xₐ may also be ascertained from the at least one setpoint variable 20 for controlling motor 14 used in the electromechanical brake booster (without using master brake cylinder pressure p/primary pressure). Equations

(Eq. 6) and (Eq. 7) may then be used to determine input rod travel xₑ and first adjustment force Fₑ transferred to input rod 22. Based on input rod travel xₑ and first adjustment force Fₑ transferred to input rod 22, the operation W performed by the user of the braking system on brake actuation element 28 may be determined according to equation (Eq. 1). The functions used to determine operation W are determined by the design of electromechanical brake booster 12 and are therefore easily programmable into evaluation electronics 16.

In one alternative specific embodiment, motor current I provided to motor 14 or resultant driving torque M_{M} of motor 14 may also be measured. Similarly, rotation speed ω of motor 14 may likewise also be measured. The measured values may then be outputted as the at least one actual variable to sensor device 10. This also permits a reliable determination of operation W performed by the user of the braking system on brake actuation element 28.

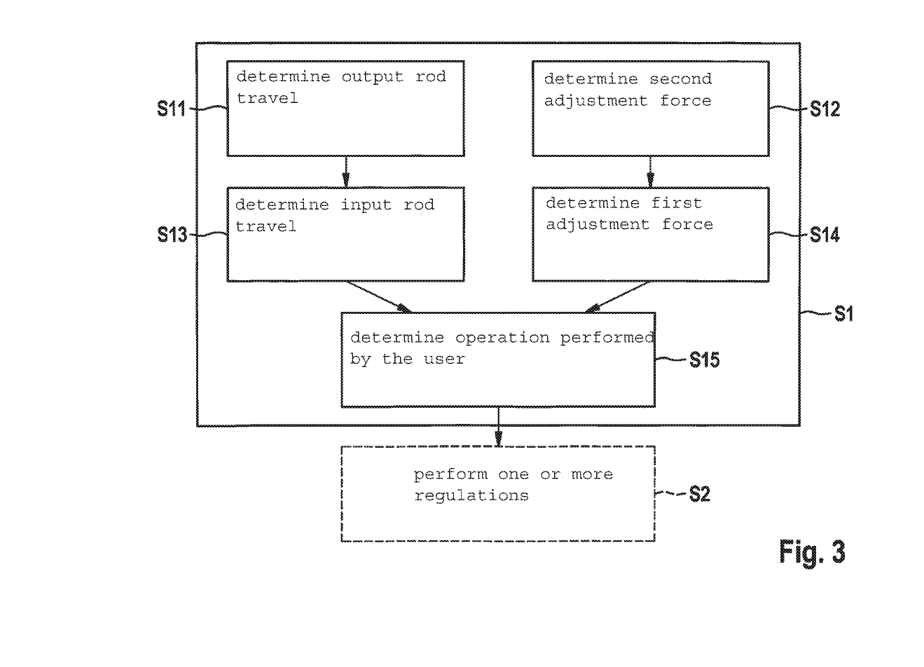

FIG. 3 shows a flow chart for explaining one specific embodiment of the method for ascertaining a braking request specification to a braking system equipped with an electromechanical brake booster.

In a method step S1, at least one braking request specification variable is determined with respect to the braking request specification of a user of the braking system. For example, an operation performed by the user of the braking system on a brake actuation element situated thereon may be determined as the at least one braking request specification variable under consideration. The at least one braking request specification variable is determined in step S1, while taking into account at least one actual variable with respect to a functionality of at least one component of the electromechanical brake booster and/or at least one setpoint variable for specifying the functionality of the at least one component of the electromechanical brake booster. Thus, in this method as well, the driver braking request detection is based on the at least one actual variable and/or on the at least one setpoint variable, which reflect a functionality of the electromechanical brake booster carried out or to be carried out. The braking request detection may, in particular, be based on signals of the electromechanical brake booster, in particular, on signals of a controller and/or actuator of the electromechanical brake booster, which are evaluated in method step S1. The at least one braking request specification variable may, for example, be determined, while taking into account a motor current to be supplied to and/or supplied to a motor of the electromechanical brake booster, a motor voltage to be applied to and/or applied to the motor of the electromechanical brake booster, a motor power to be applied by and/or applied by the motor of the electromechanical brake booster, a motor rotation angle to be carried out by and/or carried out by the motor of the electromechanical brake booster, a rotation speed to be carried out and/or carried out by the motor of the electromechanical brake booster, an adjustment travel of at least one component of a mechanism of the electromechanical brake booster to be carried out and/or carried out and/or a force to be applied to and/or applied to the at least one component of the mechanism of the electromechanical brake booster as the at least one actual variable and/or the at least one setpoint variable. A drive torque of an actuator of the electromechanical brake booster may, in particular, be used to ascertain the braking request specification.

A separation of mechanical and hydraulic components of the braking system is also implemented when carrying out method step S1, as a result of which the problem of the greatly differing dynamics between the braking request specification and the hydraulics described above is solved. An influence of pressure fluctuations occurring in the master brake cylinder on the at least one braking request specification variable determined in method step S1 is therefore virtually eliminated. The method described herein also ensures the other advantages described above.

Method step S1, by way of example, includes sub-steps S11 through S15 in the specific embodiment of FIG. 3. In a sub-step S11, at least one output rod travel of an output rod of the electromechanical brake booster is determined, while taking the at least one actual variable and/or the at least one setpoint variable into account. For this purpose, the motor current to be supplied to and/or supplied to a motor of the electromechanical brake booster and/or the rotation speed to be carried out and/or carried out by the motor of the electromechanical brake booster are evaluated, for example. Similarly, a second adjustment force applied to the output rod may be determined in a sub-step S12, while taking the at least one actual variable and/or the at least one setpoint variable into account. In another sub-step S13, an input rod travel of an input rod of the electromechanical brake booster is determined, while taking the output rod travel into account. In addition, a first adjustment force applied to the input rod is determined in a sub-step S14, while taking the second adjustment force into account. Sub-steps S13 and S14 may be carried out by utilizing the transfer functions specified above. Finally, the operation performed by the user of the braking system on the brake actuation element is determined in a sub-step S15, while taking the input rod travel and the first adjustment force into account.

In an optional method step S2, an ABS regulation, an ESP regulation, an ACC regulation, a recuperation regulation, a regulation of an auxiliary braking system, a regulation of a hydraulic brake boosting and/or a regulation of a generator of the braking system may be carried out, while taking the at least one braking request specification variable (determined in method step S1) into account. Thus, a method for operating the braking system equipped with the electromechanical brake booster based on method step S1 may be carried out in a varied manner.

1-13. (canceled)

14. A sensor device for a braking system equipped with an electromechanical brake booster, comprising:
evaluation electronics configured to determine at least one braking request specification variable with respect to a braking request specification of a user of the braking system, while taking at least one provided variable into account;
wherein the evaluation electronics are also configured to determine the at least one braking request specification variable, while taking into account at least one of: i) at least one actual variable with respect to a functionality of at least one component of the electromechanical brake booster, and ii) at least one setpoint variable for specifying the functionality of the at least one component of the electromechanical brake booster as the at least one provided variable.

15. The sensor device as recited in claim 14, wherein the evaluation electronics are configured to determine the at least one braking request specification variable, while taking into account at least one of: i) a motor current to be provided to or provided to a motor of the electromechanical brake booster, ii) a motor voltage to be applied to or applied to the motor of the electromechanical brake booster, iii) a motor power to be applied by or applied by the motor of the electromechanical brake booster, iv) a motor rotation angle to be carried out by or carried out by the motor of the electromechanical brake booster, v) a rotation speed to be carried out or carried out by the motor of the electromechanical brake booster, an adjustment travel of at least one component of a mechanism of the electromechanical brake booster to be carried out or carried out, vi) a force to be applied to or applied to the at least one component of the mechanism of the electromechanical brake booster, as the at least one of the at least one actual variable and the at least one setpoint variable.

16. The sensor device as recited in claim 14, wherein the evaluation electronics are configured to determine an operation performed by the user of the braking system on a brake actuation element situated thereon as the at least one braking request specification variable, while taking the at least one of the actual variable and the setpoint variable, into account.

17. The sensor device as recited in claim 16, wherein the evaluation electronics are configured to determine at least one input rod travel of an input rod of the electromechanical brake booster and a first adjustment force applied to the input rod, while taking the at least one of the actual variable and the setpoint variable, into account and to determine the operation performed by the user of the braking system on the brake actuation element, while taking the input rod travel and the first adjustment force into account.

18. The sensor device as recited in claim 17, wherein the evaluation electronics are configured to determine at least one output rod travel of an output rod of the electromechanical brake booster and a second adjustment force applied to the output rod, while taking the at least one of the actual variable and the setpoint variable, into account, and to determine the input rod travel and the first adjustment force, while taking the output rod travel and the second adjustment force into account.

19. A controller for a braking system equipped with an electromechanical brake booster, including a sensor device including evaluation electronics configured to determine at least one braking request specification variable with respect to a braking request specification of a user of the braking system, while taking at least one provided variable into account, wherein the evaluation electronics are also configured to determine the at least one braking request specification variable, while taking into account at least one of: i) at least one actual variable with respect to a functionality of at least one component of the electromechanical brake booster, and ii) at least one setpoint variable for specifying the functionality of the at least one component of the electromechanical brake booster as the at least one provided variable, wherein the controller is configured for at least one of: an ABS regulation, an ESP regulation, an ACC regulation, a recuperation regulation, a regulation of an auxiliary braking system, a regulation of a hydraulic brake booster, and a regulation of a generator of the braking system being implementable, while taking the at least one braking request specification variable into account.

20. A braking system for a vehicle, comprising:
an electromechanical brake booster; and
a sensor device including evaluation electronics configured to determine at least one braking request specification variable with respect to a braking request specification of a user of the braking system, while taking at least one provided variable into account, wherein the evaluation electronics are also configured to determine the at least one braking request specification variable, while taking into account at least one of: i) at least one actual variable with respect to a functionality of at least one component of the electromechanical brake booster, and ii) at least one setpoint variable for specifying the functionality of the at least one component of the electromechanical brake booster as the at least one provided variable.

21. A method for ascertaining a braking request specification to a braking system equipped with an electromechanical brake booster, comprising:
determining at least one braking request specification variable with respect to the braking request specification of a user of the braking system, while taking at least one provided variable into account;
wherein the at least one braking request specification variable is determined, while taking into consideration at least one of: i) at least one actual variable with respect to a functionality of at least one component of the electromechanical brake booster, and ii) at least one setpoint variable for specifying the functionality of the at least one component of the electromechanical brake booster as the at least one provided variable.

22. The method as recited in claim 21, wherein the at least one braking request specification variable is determined while taking into account at least one of: i) a motor current to be provided to and/or provided to a motor of the electromechanical brake booster, ii) a motor voltage to be applied to and/or applied to the motor of the electromechanical brake booster, iii) a motor power to be applied by and/or applied by the motor of the electromechanical brake booster, iv) a motor rotation angle to be carried out by and/or carried out by the motor of the electromechanical brake booster, v) a rotation speed to be carried out and/or carried out by the motor of the electromechanical brake booster, vi) an adjustment travel of at least one component of a mechanism of the electromechanical brake booster to be carried out and/or carried out, and vii) a force to be applied to and/or applied to the at least one component of the mechanism of the electromechanical brake booster, as the at least one of the actual variable and the setpoint variable.

23. The method as recited in claim 21, wherein an operation performed by the user of the braking system on a brake actuation element situated thereon is determined as the at least one braking request specification variable, while taking the at least one of the actual variable and the setpoint variable into account.

24. The method as recited in claim 23, wherein at least one input rod travel of an input rod of the electromechanical brake booster and an adjustment force applied to the input rod are determined, while taking the at least one of the actual variable and the setpoint variable, into account, the operation performed by the user of the braking system on the brake actuation element being determined, while taking the input rod travel and the first adjustment force into account.

25. The method as recited in claim 24, wherein at least one output rod travel of an output rod of the electromechanical brake booster and a second adjustment force applied to the output rod are determined, while taking the at least one of the actual variable and the setpoint variable, into account, and the input rod travel and the first adjustment force being determined, while taking the output rod travel and the second adjustment force into account.

26. A method for operating a braking system equipped with an electromechanical brake booster, comprising:
determining at least one braking request specification variable with respect to the braking request specification of a user of the braking system, while taking at least one provided variable into account, wherein the at least one braking request specification variable is determined, while taking into consideration at least one of: i) at least one actual variable with respect to a functionality of at least one component of the electromechanical brake booster, and ii) at least one setpoint variable for specifying the functionality of the at least one component of the electromechanical brake booster as the at least one provided variable; and
carrying out at least one of: an ABS regulation, an ESP regulation, an ACC regulation, a recuperation regulation, a regulation of an auxiliary braking system, a regulation of a hydraulic brake booster, and a regulation of a generator of the braking system, while taking the at least one determined braking request specification variable into account.
